(19) United States
(12) Patent Application Publication
(10) Pub. No.: US 2025/0261631 A1
(43) Pub. Date: Aug. 21, 2025

(54) ADJUSTABLE WATERFOWL DECOY

(71) Applicant: Fowl Innovations LLC, New Iberia, LA (US)

(72) Inventors: Corey Halsell, New Iberia, LA (US); Andrew Girouard, New Iberia, LA (US); Ross Byrley, Lake Charles, LA (US)

(21) Appl. No.: 19/055,381

(22) Filed: Feb. 17, 2025

Related U.S. Application Data
(60) Provisional application No. 63/554,321, filed on Feb. 16, 2024.

(51) Int. Cl. A01M 31/06

(52) U.S. Cl. CPC A01M 31/06

(57) ABSTRACT

A decoy system for land and water use includes a motion stand, a decoy float, and an adjustable waterfowl decoy. The decoy has a decoy body with an upper portion and a lower belly portion. A motion stand adapter is adjacent the upper portion of the decoy body for operatively coupling the adjustable waterfowl decoy to the motion stand such that the decoy body is configured to sway on the motion stand in a breeze. A float adapter is adjacent the lower belly portion to releasably couple to the decoy float such that the decoy float for floating the adjustable waterfowl decoy on a body water.

### CROSS-REFERENCE TO RELATED APPLICATION

This application claims the benefit of U.S. Provisional Application No. 63/554,321 filed on Feb. 16, 2024, the entire disclosure of which is incorporated herein by reference.

### BACKGROUND

Land and water decoys are widely used by hunters to attract waterfowl within hunting range. Generally, hunters will use several different types of decoy to replicate the appearance and behaviors of waterfowl flocks within particular areas. For example, hunters will assemble floating decoys on a pond to mimic behaviors of swimming waterfowl. Alternatively, separate land decoys are used for mimicking land behaviors of waterfowl on a field.

### SUMMARY

Aspects of the present disclosure permit an adjustable waterfowl decoy configured for attachment to a motion stand for mounting the decoy on land and a decoy float for floating the decoy on a body of water.

In one aspect, an adjustable waterfowl decoy for land and water use comprises a decoy body having an upper portion and a lower belly portion. A motion stand adapter is adjacent the upper portion of the decoy body and configured for operatively coupling the adjustable waterfowl decoy to a motion stand such that the decoy body is configured to sway on the motion stand in a breeze. A float adapter is adjacent the lower belly portion. The float adapter is configured to releasably couple to a decoy float such that the decoy float is configured to float the adjustable waterfowl decoy on a body of water.

In another aspect, a decoy system for land and water use comprises a motion stand, a decoy float, and an adjustable waterfowl decoy comprising a decoy body having an upper portion and a lower belly portion. A motion stand adapter is adjacent the upper portion of the decoy body and configured for operatively coupling the adjustable waterfowl decoy to the motion stand such that the decoy body is configured to sway on the motion stand in a breeze. A float adapter is adjacent the lower belly portion. The float adapter is configured to releasably couple to the decoy float such that the decoy float is configured to float the adjustable waterfowl decoy on a body water.

A method for configuring an adjustable waterfowl decoy for land and water use comprises separating a decoy float from a float adapter of the adjustable waterfowl decoy to expose a belly opening of the adjustable waterfowl decoy. A first end portion of a motion stand is inserted through the exposed belly opening into an interior space of the adjustable waterfowl decoy. The first end portion of the motion stand is engaged with a motion stand adapter in the interior space such that the adjustable waterfowl decoy is configured to sway on the motion stand in a breeze.

Other objects and features will be in part apparent and in part pointed out hereinafter.

### BRIEF DESCRIPTION OF THE DRAWINGS

FIG. 1 is a cross section of an adjustable waterfowl decoy on a motion stand, where a decoy body is shown schematically.

FIG. 2 is a fragmentary perspective of the adjustable waterfowl decoy on the motion stand.

FIG. 3 is an elevation of the adjustable waterfowl decoy on a decoy float.

FIG. 4 is a perspective of the adjustable waterfowl decoy with the decoy float.

FIG. 5 is an illustration of a decoy insert with the decoy float installed.

FIG. 6 is an elevation of the decoy insert.

FIG. 7 is a top plan view of the decoy insert.

FIG. 8 is another elevation of the decoy insert.

FIG. 9 is a bottom plan view of the decoy insert.

FIG. 10 is a perspective of the decoy float.

FIG. 11 is a top plan view of the decoy float.

FIG. 12 is an elevation of the decoy float.

FIG. 13 is an illustration of a decoy system according to an alternative embodiment.

FIG. 14. is an illustration of an adjustable waterfowl decoy of the decoy system of

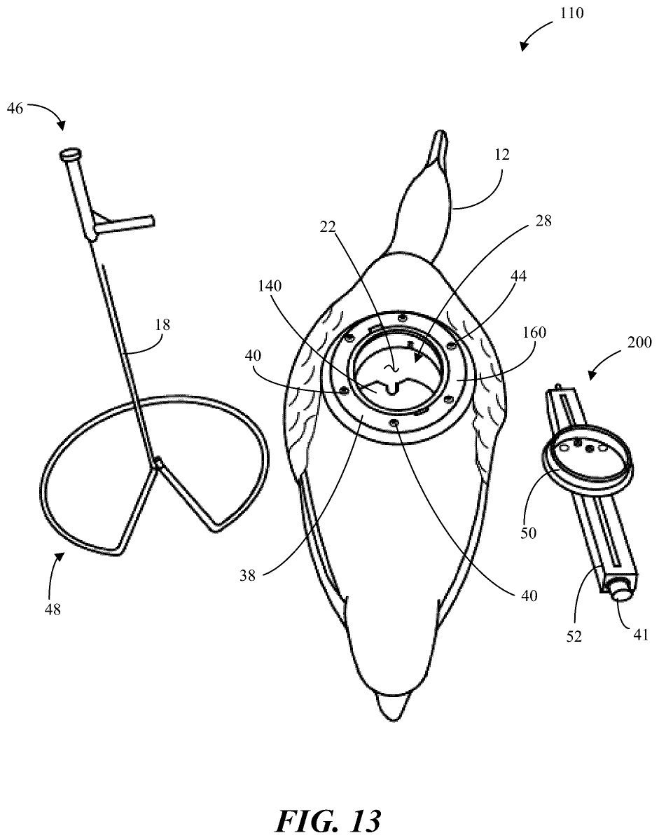

FIG. 13 on a motion stand.

FIG. 15. is an illustration of the adjustable waterfowl decoy of FIG. 13 with a decoy float installed.

FIG. 16 is an enlarged illustration of a portion of the adjustable waterfowl decoy of FIG. 13.

Corresponding reference characters indicate corresponding parts throughout the drawings.

### DETAILED DESCRIPTION

Waterfowl decoys are used to attract waterfowl to particular hunting areas. Typically, decoys are configured for either land or water use. For example, conventional land decoys are generally configured to replicate the physical appearance and behaviors of waterfowl on land, whereas conventional water decoys are generally configured to float on water and replicate the appearance and behaviors of waterfowl on water. Accordingly, hunters must obtain a number of different decoys for hunting waterfowl in both field and pond settings. Conventional attempts for configuring waterfowl for both land and water use, involve the use of stands configured to receive or fit onto a floating portion (e.g., a keel) of a water decoy to mount the water decoy on land. The inventors have recognized that one difficulty with conventional attempts for configuring decoys for land and water use is realism. For example, conventional stands are configured to rigidly hold floating portions of water decoys, which restricts the decoy from having life-like motion. As will be described in further detail below, this disclosure generally pertains to an adjustable waterfowl decoy that is configured to be realistically and easily adapted for land and water use.

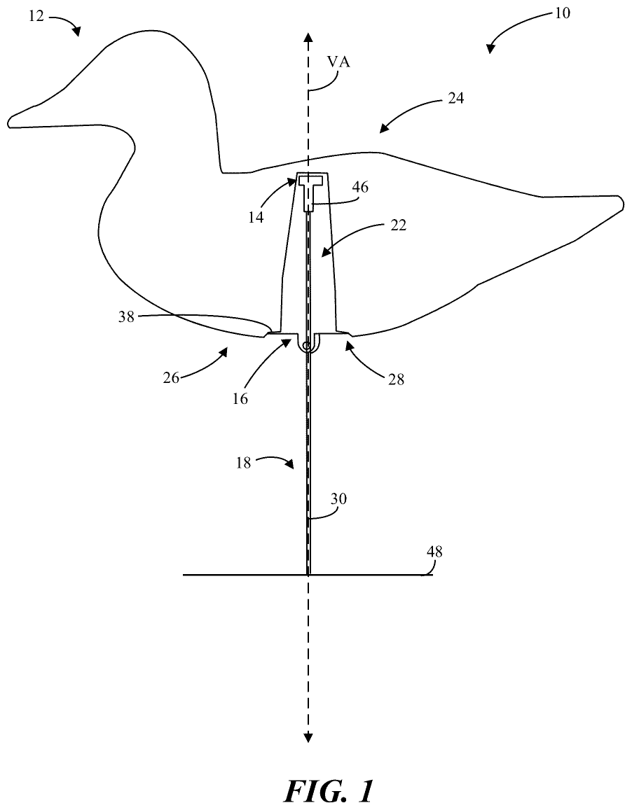

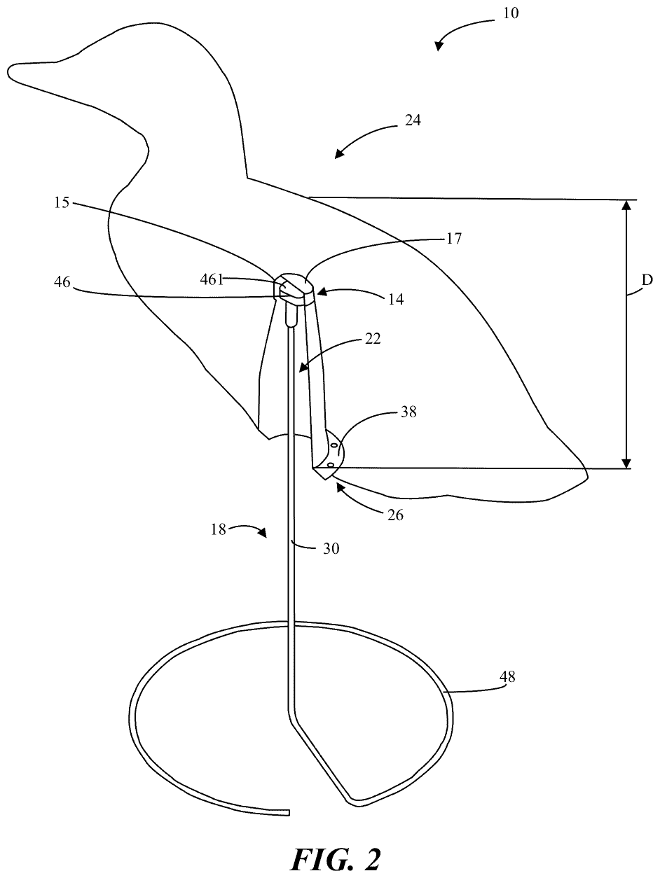

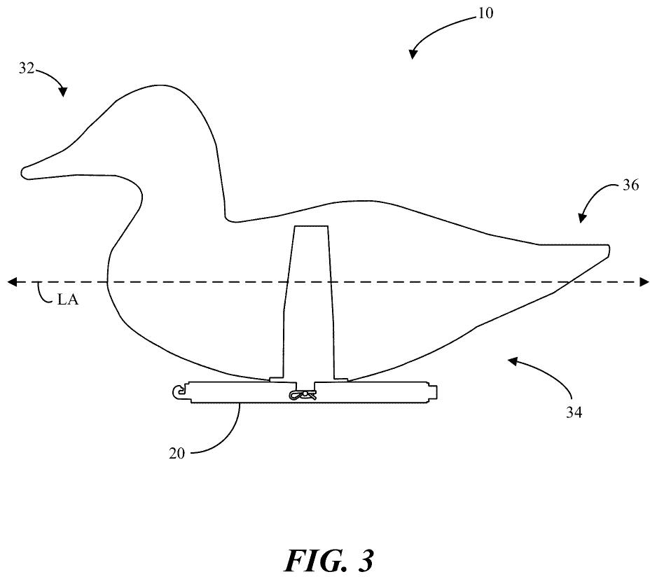

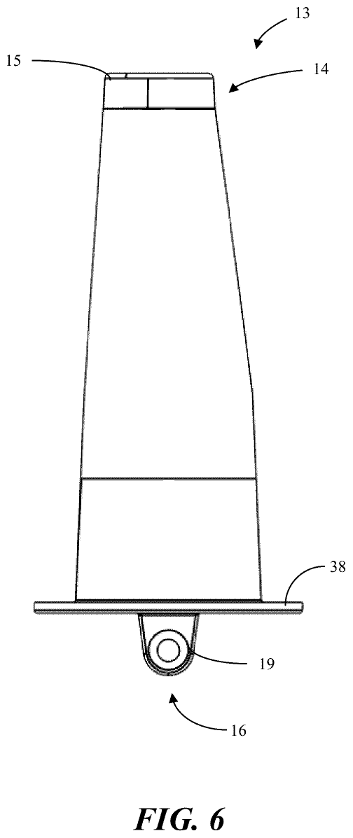

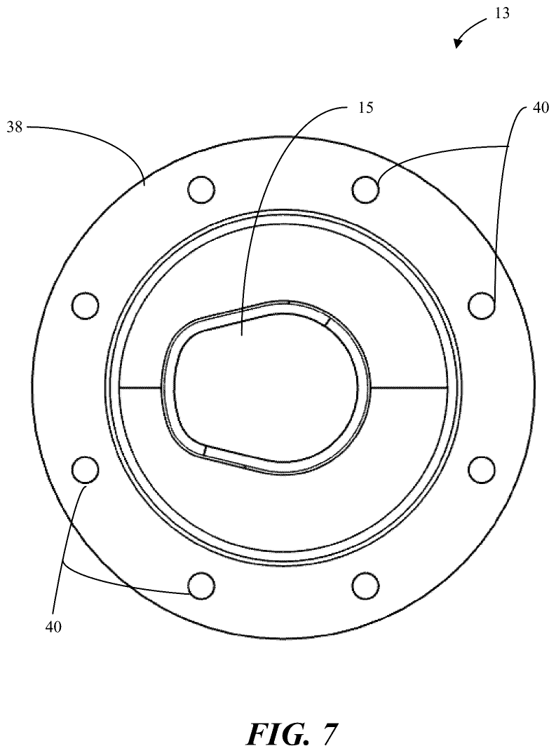

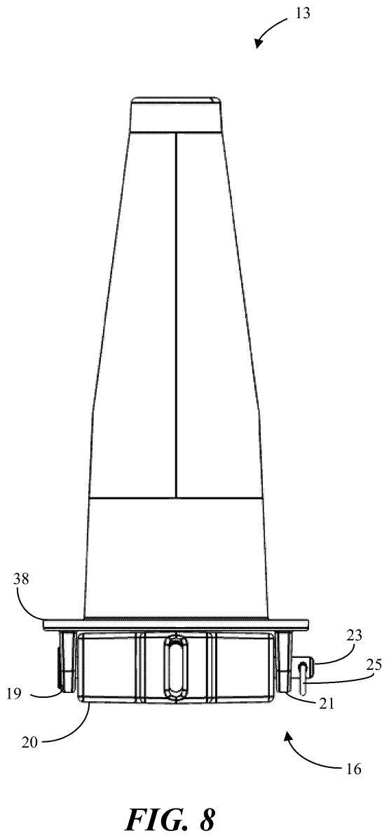

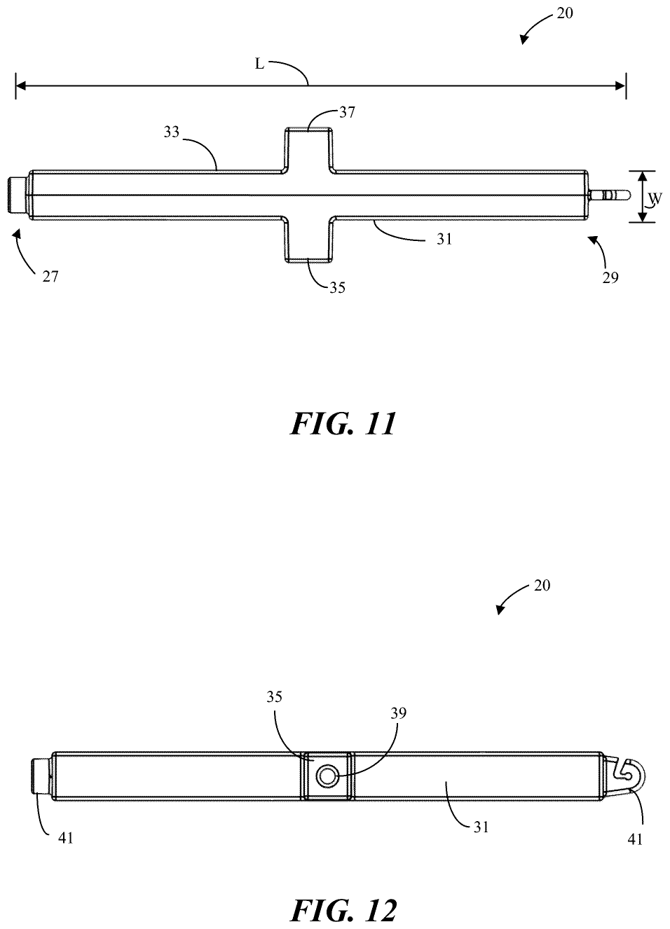

Referring now to FIGS. 1-4, an exemplary embodiment of a decoy system in accordance with the present disclosure is generally indicated at reference number 10. The decoy system 10 comprises an adjustable waterfowl decoy 12 with an internal motion stand adapter 14 for configuring the decoy for land use and a float adapter 16 for configuring the decoy for water use. In the illustrated embodiment, the motion stand adapter 14 and float adapter 16 are formed as a single piece decoy insert 13 (FIGS. 1-9). However, it will be understood that the motion stand adapter and the float adapter could be formed as separate pieces and attached to the decoy 12 individually. The decoy system 10 further comprises a motion stand 18 (FIGS. 1-2) and a decoy float 20 (FIGS. 3-5, 10-12). As explained more fully below, the motion stand adapter 14 is configured for operatively coupling the decoy 12 to the motion stand 18 such that the decoy is configured to sway on the motion stand in a breeze. The float adapter 16 is configured to releasably couple to the decoy float 20 such that the decoy float is configured to float the decoy 12 on a body of water. In this way, the adjustable water fowl decoy 12 is easily reconfigurable for stand-mounted user with lifelike motion or waterborne use, thus eliminating the need for separate decoys for different applications.

The decoy 12 comprises a decoy body (shown schematically in FIGS. 1-4) having an upper portion 24 and a lower belly portion 26 spaced apart vertically along a vertical axis VA of the decoy body (FIG. 1). The motion stand adapter 14 is located adjacent the upper portion 24 of the decoy body and the float adapter 15 is located adjacent the lower belly portion. The decoy 12 has a belly opening 28 along the lower belly portion 26, which communicates with an interior space 22 inside the decoy. In the illustrated embodiment, the interior space 22 and belly opening 28 are defined by the decoy insert 13. As will be described in further detail below, the belly opening 28 is configured such that a stake 30 of the motion stand 18 is passable through the belly opening into engagement with the motion stand adapter 14. Furthermore, the belly opening 28 is sized and arranged to provide clearance between the stake 30 and the decoy body 360° about the stake when the motion stand 18 is operatively coupled to the motion stand adapter 14.

As shown in FIG. 3, the decoy body comprises a front portion 32 and a rear portion 36 spaced apart along a longitudinal axis LA of the decoy body. A center portion 34 is located between the front portion 32 and the rear portion 36. In a preferred embodiment, the motion stand adapter 14, float adapter 16, and belly opening 28 are all located at the center portion 34 and about centered on the vertical axis VA (e.g., within 20% of the diameter of the belly opening from center with respect to the vertical axis). It will be understood that the decoy body may be shaped and arranged to appear like waterfowl in poses such as a feeding pose, floating pose, standing pose, laying pose, flying pose, or landing pose. In a preferred embodiment, the decoy body is formed of at least one of a lightweight, water-resistant, and/or buoyant material.

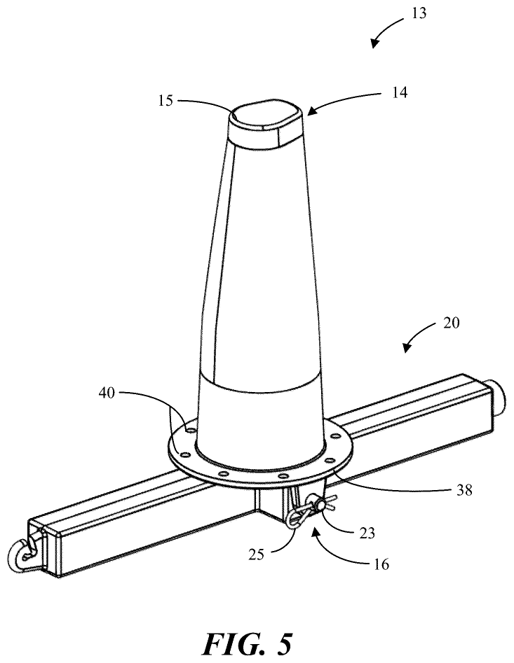

The decoy insert 13 is mounted at the center portion 34 of the decoy body for balance. The decoy insert 13 is shaped and arranged so that the motion stand adapter 14 and float adapter 16 are spaced apart vertically from one another along the vertical axis VA. In the illustrated embodiment, the decoy insert 13 comprises a flange 38 (FIG. 5) adjacent the lower belly portion of 26 the decoy body where the decoy insert 13 is fastened to the decoy body. The flange may be considered part of the float adapter 16 in the illustrated embodiment.

The motion stand adapter 14 is configured for operatively coupling the adjustable waterfowl decoy 12 to the motion stand 18 such that the decoy body is configured to sway on the motion stand in a breeze. For example, the motion stand adapter 14 comprises a receiver 15 that is configured to loosely receive the motion stand 18 to permit life-like motion of the adjustable waterfowl decoy 12 on the motion stand to mimic land behaviors and appearances of waterfowl, particularly when viewed by waterfowl in-flight from a vantage point above the decoy. In a preferred embodiment, the motion stand adapter 14 is spaced apart vertically from the float adapter 16 along the vertical axis VA such that the motion stand adapter 14 is seated above the float adapter 16.

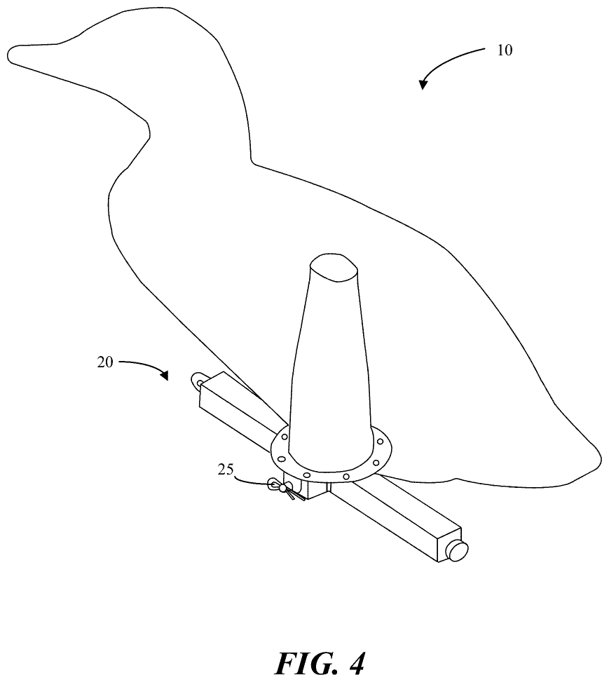

As shown in FIGS. 2 and 4, the motion stand adapter 14 comprises an inverted cup-shaped receiver 15 having an elongate, rather than circular, shape. The receiver 15 has a top wall, and a centrally located conical projection 17 protruding downward from the top wall. As explained below, conical projection 17 is configured to support the adjustable waterfowl decoy 12 on the motion stand 18.

The motion stand 18 comprises a stake 30 with the first end portion 46 configured for insertion through the belly opening 28 for operatively coupling to the motion stand adapter 14, and a second end portion 48 for mounting the decoy 12 on ground for land use. In general, the first end portion 46 is configured to loosely couple to the motion stand adapter 14 for supporting the decoy 12 above ground so that the decoy sways on the stand 18 in a breeze. More specifically, the first end portion 46 of the motion stand 18 comprises a fitting that defines a conical recess 461 for receiving the conical projection 17. The conical projection 17 being received in the conical recess 461 creates a rotational bearing that allows the adjustable waterfowl decoy 12 to rotate relative to the motion stand. The fitting 46 has an elongate shape that fits into the cup-shaped receiver 15 with some clearance. The clearance is such that the motion stand adapter 14 and the fitting 46 can rotate relative to one another in a limited range of motion, delimited by first and second rotational positions at which the fitting engages opposite side walls of the cup-shaped receiver 15. The decoy body moves conjointly with motion stand adapter 14. Moreover, the decoy 12 is configured (e.g., made of sufficiently lightweight materials) so that the decoy moves on the motion stand within the limited range permitted by the motion stand adapter 14 under even a light breeze. Motion of the decoy body within the limited range permitted by the motion stand adapter 14 and the fitting 46 has a realistic effect when viewed from above.

In the illustrated embodiment, the second end portion 48 of the motion stand 18 defines a foot configured to rest on top of the ground. In other embodiments, the second end portion 48 can comprise a spike for inserting the motion stand 18 into the ground. Additionally, the motion stand 18 may be shaped and arranged to replicate a physical appearance of waterfowl legs and feet. Other configurations of motion stands may be used without departing from the scope of the present disclosure.

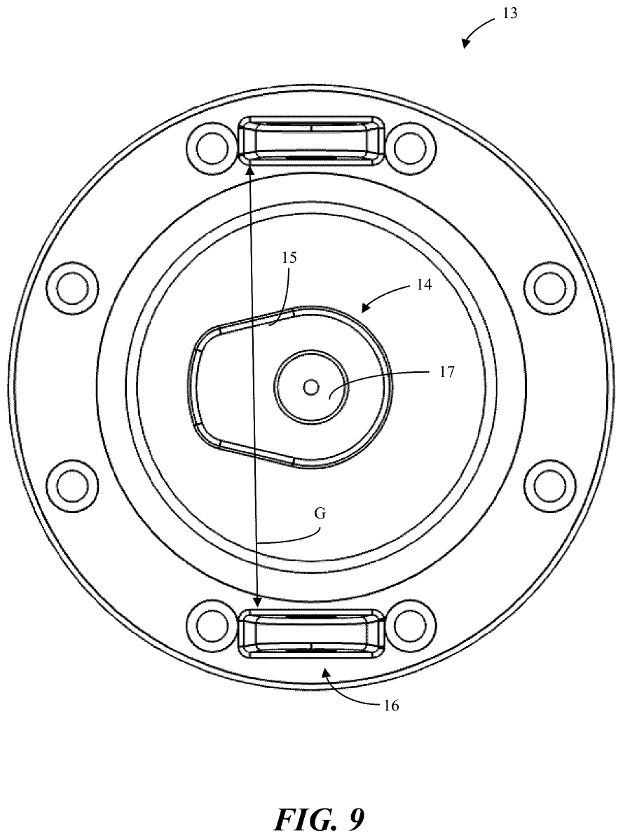

The float adapter 16 is configured to releasably couple to the decoy float 20 such that the decoy float is configured to float the adjustable waterfowl decoy 12 on a body of water. The float adapter 16 is located on the decoy body adjacent the lower belly portion 26, at the center portion 34. The float adapter 16 comprises the flange 38 and first and second prongs 19, 21 protruding downward on opposite sides of the flange 38 (more broadly, on opposite sides of the belly opening 28) such that the first and second prongs are spaced apart by a gap G (FIG. 9). The decoy float 20 is configured to be secured to the first and second prongs 19, 21 in the gap G. In one example, the decoy float 20 is secured to the first and second prongs 19, 21 with a pin 23 inserted through the first prong, decoy float, and second prong. Additionally, a cotter pin 25 may be used to retain the pin 23 on the float adapter 16.

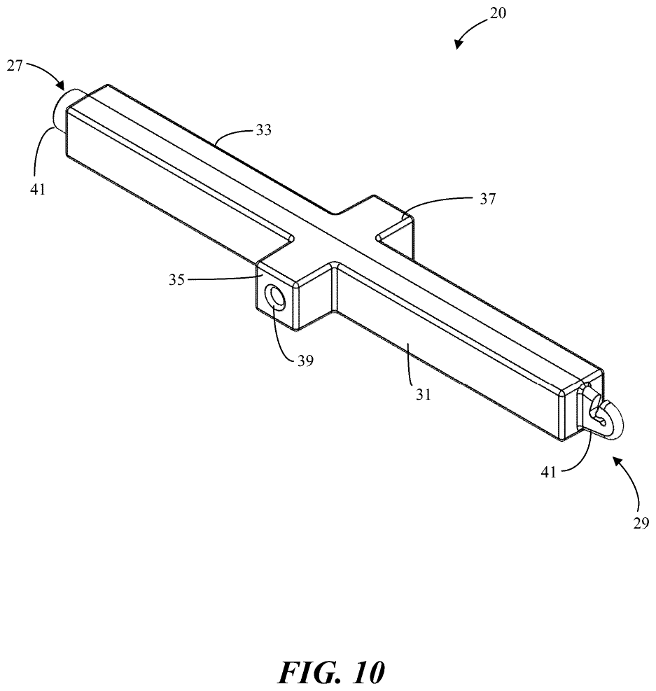

In general, the decoy float 20 is configured to couple to the float adapter 16 to float and stabilize the decoy 12 on a body of water. In one example, the decoy float 20 comprises a keel having a first end portion 27, a second end portion 29, a length L extending from the first end portion to the second end portion, a first lateral side 31, a second lateral side 33, and a width W extending from the first lateral side to the second lateral side (FIGS. 10-12). Furthermore, the keel comprises a first gap-filling protrusion 35 on the first lateral side 31, and a second gap-filling protrusion 37 on the second lateral side 33. The keel also defines a pin opening 39 extending widthwise through the first gap-filling protrusion 35, the keel, and the second gap-filling protrusion 37 for receiving the pin 23. In a preferred embodiment, at least one of the first and second end portions 27, 29 of the keel comprises an anchor line attachment 41 for anchoring the decoy 12 while floating on the body of water. For example, an anchor line (not shown) is configured to attach to the anchor line attachment 41 for rigging the decoy 12 for water use.

A method of using the decoy system to configure the adjustable decoy 12 for land and water use will now be described. To configure the decoy 12 for land or water use, the motion stand 18 or decoy float 20 is installed to the decoy by a waterfowl hunter in the field, e.g., in hunting areas. For example, to use the adjustable decoy 12 on land, a hunter couples the motion stand 18 to the motion stand adapter 14 and mounts the motion stand on the ground. To use the adjustable decoy 12 on water, the hunter couples the decoy float 20 to the float adapter 16 by inserting the pin 23 through the first prong 19, opening 39, and second prong 21, and by installing the cotter pin 25 to retain the pin on the float adapter. Furthermore, the hunter secures an anchor and anchor line to the anchor line attachment 41, and positions the decoy on the pond.

It can be seen that the decoy system described above allows a hunter to use the same decoy either on land or on water. Moreover, this enhanced capability is achieved without compromising the lifelike motion of the decoy on land or on water. The decoy achieves a lifelike motion on land and on water that is on par with the highest performing single-application decoys on the market today.

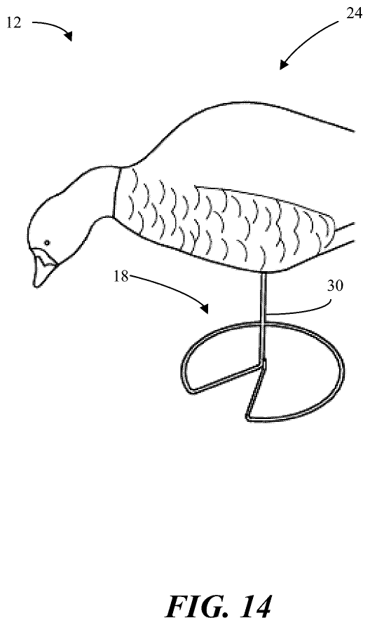

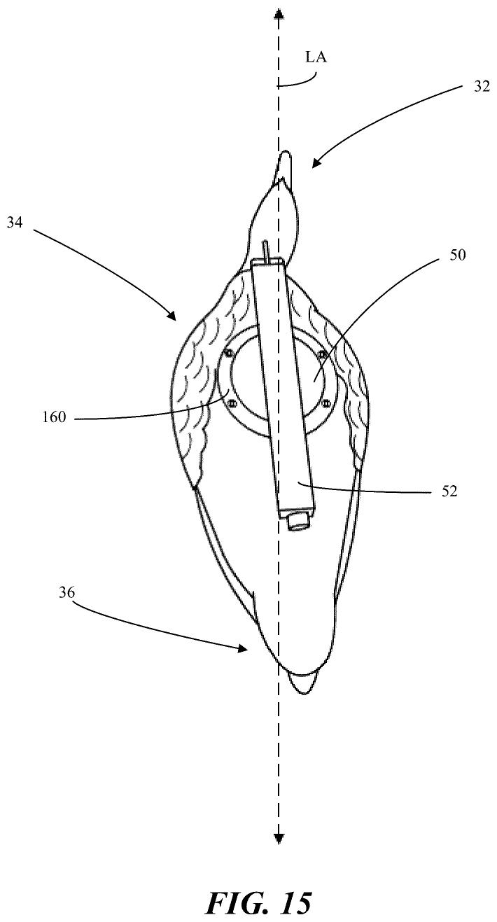

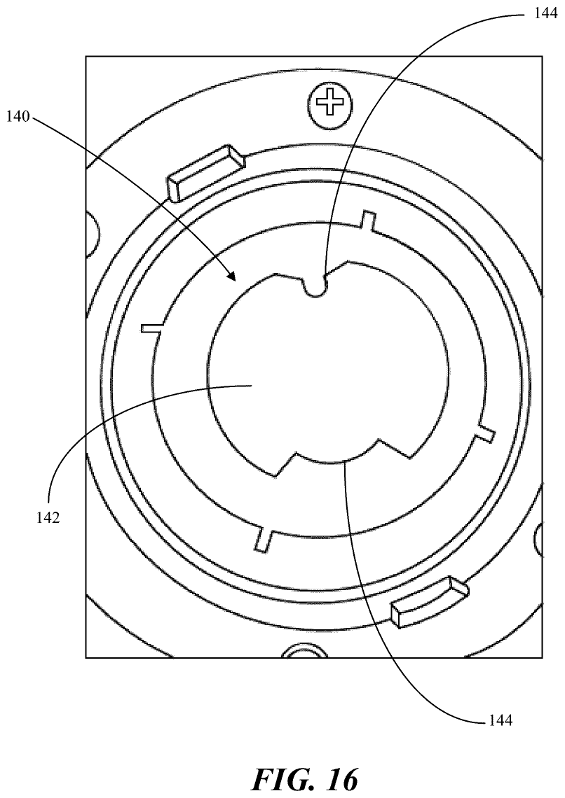

Referring now to FIGS. 13-16, another embodiment of a decoy system according to the present disclosure is generally indicated at reference number 110. The decoy system 110 is similar to the decoy system 10 of FIGS. 1-12, with the main difference being that the motion stand adapter 140 and float adapter 160 are formed as separate pieces. For ease of description, where similar, analogous, or identical parts are used, identical reference numbers are employed. Accordingly, unless clearly stated or indicated otherwise, the descriptions regarding the decoy system 10 of FIGS. 1-12 also apply to the decoy system 110 of FIGS. 13-16.

Similar to above, the motion stand adapter 140 comprises a receiver configured to loosely receive a portion of the motion stand 18. Furthermore, the motion stand adapter 140 is mounted within the interior space 22 of the decoy 12 at the upper portion 24 of the decoy body. In this embodiment, the motion stand adapter 140 comprises plate 142 that engages the first end portion 46 of the motion stand 18, and a stopper portion 144 configured to limit rotation of the decoy 12 on the motion stand 18 (FIG. 16).

The float adapter 160 comprises a fluid coupler. When coupled with the decoy float 200, the illustrated float adapter 160 is configured to plug and seal the belly opening 28 watertight to prevent water from entering the interior space 22. In one example, the float adapter 160 comprises a rim 44 configured to receive a plug of the decoy float 200 (FIG. 13). The rim 44 includes an inner annular wall extending upward along the vertical axis VA into the interior space 22 of the decoy body. It will be apparent to a person of ordinary skill in the art that other coupling devices (for example, but without limitation, other fluid couplers) may be used as the float adapter 160 without departing from scope of the present disclosure.

The decoy float 200 comprises a plug 50 secured to a keel 52. As shown in FIG. 15, the plug 50 is configured to couple to the float adapter 160 for sealing the belly opening 28 watertight. In the illustrated embodiment, the plug 50 is configured to make a simple bung fitting connection to the float adapter 160. In certain embodiments, the plug can be configured to make a bayonet connection to the float adapter 160. Moreover, the keel 52 provides a handle for easily twisting the decoy float 200 in relation to the float adapter 160 to couple and decouple the decoy float 200 from the decoy 12.

The decoy system 110, as discussed above, is used for configuring a decoy for land and water use. A method of using the decoy system 110 to configure the adjustable decoy 12 for land and water use will now be described. For purposes of completeness, the method begins with installing the motion stand adapter 140 and float adapter 160 to the adjustable decoy 12. The motion stand adapter 140 is installed within the interior space 22 of the decoy 12 such that it is configured to operatively couple the decoy to the motion stand 18, while permitting the decoy to sway on the stand in a breeze. The float adapter 160 is installed adjacent the lower belly portion 26 of the decoy 12 such that it is configured to releasably couple the decoy to the decoy float 200 for floating the decoy on water. The motion stand adapter 140 and float adapter 160 are preferably pre-manufactured components of the adjustable decoy 12, made and assembled by a manufacturer of the adjustable decoy 12. In another embodiment, the motion stand adapter 140 and float adapter 160 could be kit components to be installed to a more conventional decoy by the end user.

To configure the decoy 12 for land or water use, the motion stand 18 or decoy float 200 is installed to the decoy by a waterfowl hunter in the field, e.g., in hunting areas. For example, to use the adjustable decoy 12 in a field, a hunter couples the motion stand 18 to the motion stand adapter 140 and mounts the motion stand on the ground. To use the adjustable decoy 12 on a pond (more broadly, for water use), the hunter couples the decoy float 200 to the float adapter 160, and secures an anchor and anchor line to the anchor line attachment 41, and positions the decoy on the pond.

Advantageously, the decoy systems 10, 110 provide user-friendly decoy systems for configuring a decoy for land or water use. Moreover, the decoy systems 10, 110 of the present disclosure provide realistic decoy that replicate the physical appearance and behavioral patterns of waterfowl on both land and water. Accordingly, systems and methods in accordance with the present disclosure eliminate a need for separate land and water decoys.

It is envisioned that all components of the decoy systems 10, 110 are formed of at least one of lightweight, water-resistant, and/or durable material. Also, it is envisioned that low-cost manufacturing techniques known in the art may be used to manufacture the components of the decoy systems 10, 110.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. An adjustable waterfowl decoy for land and water use, the adjustable waterfowl decoy comprising:
a decoy body having an upper portion and a lower belly portion;
a motion stand adapter adjacent the upper portion of the decoy body configured for operatively coupling the adjustable waterfowl decoy to a motion stand such that the decoy body is configured to sway on the motion stand in a breeze; and
a float adapter adjacent the lower belly portion, the float adapter configured to releasably couple to a decoy float such that the decoy float is configured to float the adjustable waterfowl decoy on a body of water.

2. The adjustable waterfowl decoy of claim 1, wherein the float adapter comprises a flange secured to the lower belly portion of the decoy body.

3. The adjustable waterfowl decoy of claim 1, wherein the decoy has a belly opening through which the motion stand is passable for engagement with the motion stand adapter.

4. The adjustable waterfowl decoy of claim 3, wherein the belly opening is sized and arranged to provide clearance between the stake and the decoy body 360° about the stake when the motion stand adapter is operatively coupled to the motion stand.

5. The adjustable waterfowl decoy of claim 1, wherein the motion stand adapter is spaced apart vertically from the float adapter along a vertical axis of the decoy body.

6. The adjustable waterfowl decoy of claim 5, wherein the motion stand adapter, the belly opening, and the float adapter are all about centered on the vertical axis.

7. The adjustable waterfowl decoy of claim 1, wherein the decoy body is formed of a water-resistant, buoyant material.

8. The adjustable waterfowl decoy of claim 1, further comprising a one-piece decoy insert, the motion stand adapter and the float adapter being integrally formed portions of the one-piece decoy insert.

9. The adjustable waterfowl decoy of claim 1, wherein the decoy body is shaped and arranged to appear like a waterfowl in a pose selected from the group of poses consisting of: a floating pose, standing pose, laying pose, flying pose, landing pose, or feeding pose.

10. A decoy system for land and water use, the decoy system comprising:
a motion stand;
a decoy float;
an adjustable waterfowl decoy comprising:
a decoy body having an upper portion and a lower belly portion;
a motion stand adapter adjacent the upper portion of the decoy body configured for operatively coupling the adjustable waterfowl decoy to the motion stand such that the decoy body is configured to sway on the motion stand in a breeze; and
a float adapter adjacent the lower belly portion, the float adapter configured to releasably couple to the decoy float such that the decoy float is configured to float the adjustable waterfowl decoy on a body of water.

11. The decoy system of claim 10, wherein the adjustable waterfowl decoy has a belly opening and wherein the motion stand comprises a first end portion configured for insertion through the belly opening, the first end portion configured for operatively coupling to the motion stand adapter, the motion stand further comprising a second end portion configured for mounting the decoy on ground.

12. The decoy system of claim 10, wherein the float adapter comprises first and second prongs protruding downward from the lower belly portion such that the first and second prongs are spaced apart by a gap, the decoy float configured be secured to the first and second prongs in the gap.

13. The decoy system of claim 12, further comprising a pin configured to be inserted through the first prong, the decoy float, and the second prong to secure the decoy float to the float adapter.

14. The decoy system of claim 13, wherein the decoy float comprises a keel having a first end portion, a second end portion, a length extending from the first end portion to the second end portion, a first lateral side, a second lateral side, and a width extending from the first lateral side to the second lateral side.

15. The decoy system of claim 14, further comprising first and second gap-filling protrusions on the first and second lateral sides and aligned along the length of the keel, the decoy float defining a pin opening extending widthwise through the first gap-filling protrusion, the keel, and the second gap-filling protrusion for receiving the pin.

16. The decoy system of claim 15, further comprising a cotter pin configured to retain the pin on the float adapter.

17. The decoy system of claim 14, wherein at least one of the first and second end portions of the keel comprises an anchor line attachment.

18. The decoy system of claim 17, further comprising an anchor line configured to attach to the anchor line attachment for rigging the adjustable waterfowl decoy for water use.

19. A method for configuring an adjustable waterfowl decoy for land and water use, the method comprising:
separating a decoy float from a float adapter of the adjustable waterfowl decoy to expose a belly opening of the adjustable waterfowl decoy;
inserting a first end portion of a motion stand through the exposed belly opening into an interior space of the adjustable waterfowl decoy;
engaging the first end portion of the motion stand with a motion stand adapter in the interior space such that the adjustable waterfowl decoy is configured to sway on the motion stand in a breeze.

20. The method of claim 19, further comprising removing the motion stand adapter from the interior space and securing the decoy float to the float adapter such that the decoy float is configured to float the adjustable waterfowl decoy on a body of water.
